(19) United States
(12) Patent Application Publication
(10) Pub. No.: US 2006/0197767 A1
(43) Pub. Date: Sep. 7, 2006

(54) Algorithm to automatically configure a SONET/SDH demultiplexer by pushing a button, and displaying a result and status thereof

(76) Inventor: Robert Geoffrey Ward, Colorado Springs, CO (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 11/072,328

(22) Filed: Mar. 7, 2005

(51) Int. Cl. H04J 3/04

(52) U.S. Cl. 345/545; 370/536

(57) ABSTRACT

A network analyzer, having a demultiplexer that demultiplexes an input signal received by the network analyzer, and a determination unit determining a frame mapping of the input signal, and automatically configuring the demultiplexer in accordance with the determined frame mapping.

### BACKGROUND OF THE INVENTION

SONET and SDH are standards used for optical networks. SONET, which stands for Synchronous Optical NETwork, is used primarily in North America and Japan, while SDH, which stands for Synchronous Digital Hierarchy, is used primarily in Europe.

The concept behind both SONET and SDH is synchronous networking, in which all clocks that drive network run at the same speed. SONET is based on the idea that separate, slower signals can be multiplexed directly onto higher speed SONET signals without intermediate stages of multiplexing. A demultiplexer is a device that demultiplexes multiplexed signals.

The base signal for SONET is an STS-1 frame. STS stands for Synchronous Transfer Signal, and specifies various levels in the SONET hierarchy. Similarly, the base signal for SDH is an STM-1 frame, where STM stands for Synchronous Transfer Mode, and specifies various levels in the SDH hierarchy. STM-1 is equivalent to STS-3c.

Each frame has three basic parts: a section overhead, a line overhead, and a synchronous payload. The section overhead holds information used to communicate between sections. The line overhead holds information for line termination equipment. And the synchronous payload holds the actual information being transmitted.

Network test equipment is used to test a network's performance. But since a SONET/SDH link to a network can be internally structured many ways, and there are no clear markers in the link to indicate how to unravel the link, setup of such test equipment can be very difficult. While this situation may not be overly burdensome for installation of telecom equipment that has to have a hard configuration for reliability, and is only configured once, test equipment may have to be configured often.

Generally, a user of such test equipment does not want to have to hook up a link to a network and then spend a lot of time configuring the test equipment. Plug and play test equipment would be preferable.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 illustrates a network analyzer according to an embodiment of the present invention, and an environment in which the embodiment may be employed;

FIG. 2 illustrates a logical structure of an asynchronous transfer mode (ATM) embodiment of the present invention;

FIG. 3 illustrates a flowchart of a method according to an embodiment of the present invention;

FIG. 4 illustrates a rocket diagram for an SDH frame;

FIG. 5 illustrates a rocket diagram for a SONET frame;

FIG. 6 illustrates a flowchart of an embodiment of an operation shown in FIG. 3;

FIG. 7 illustrates an example of a transport overhead of a frame; and

FIGS. 8-20 are flowcharts illustrating embodiments of operations shown in FIG. 6.

### DETAILED DESCRIPTION

Reference will now be made in detail to embodiments of the present invention, examples of which are illustrated in the accompanying drawings, wherein like reference numerals refer to the like elements throughout. The embodiments described below explain the present invention by referring to the figures.

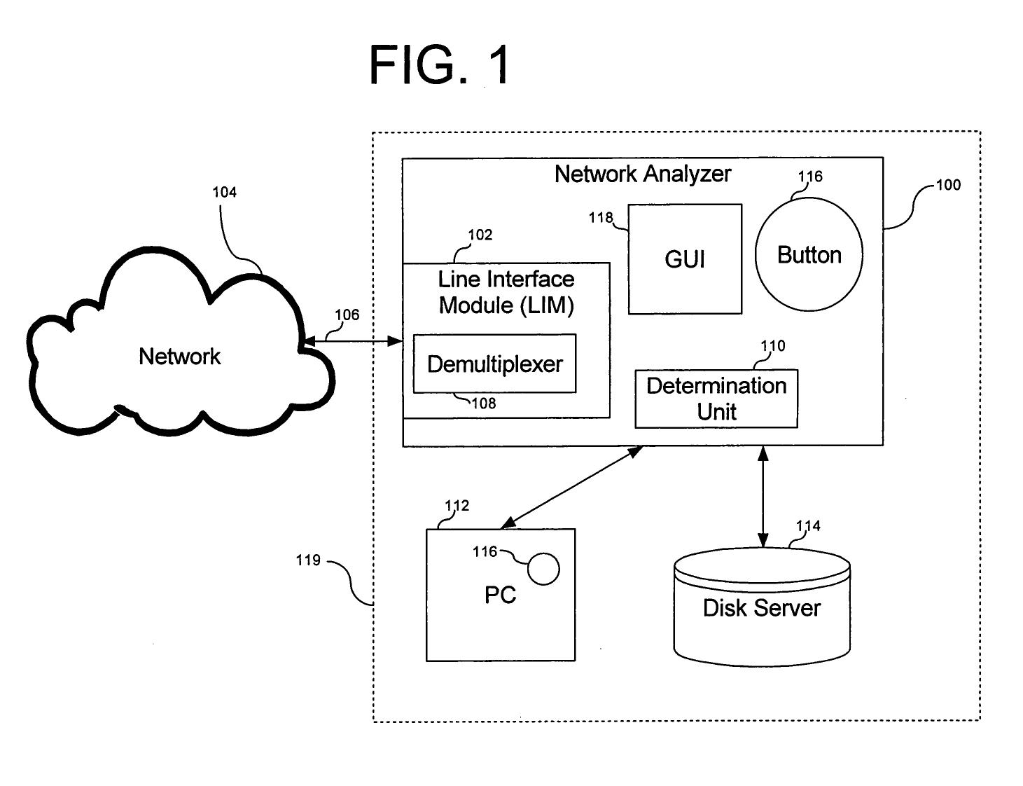

FIG. 1 illustrates a network analyzer according to an embodiment of the present invention, and an environment in which the embodiment may be employed. In FIG. 1, a network analyzer 100 has a line interface module (LIM) 102. The network analyzer 100 may be, for example, a distributed network analyzer. The LIM 102 interfaces with a network 104 and receives an input signal 106 from the network 104. The network analyzer 100 also has a demultiplexer 108 that demultiplexes the input signal 106 received by the network analyzer 100, and a determination unit 100 that determines a frame mapping of the input signal 106, and automatically configures the demultiplexer 108 in accordance with the determined frame mapping.

Herein, “automatically” means being performed by a computer without human intervention.

The demultiplexer 108 may be automatically configured in accordance with the determined frame mapping by software that writes to configuration registers on the demultiplexer 108. According to one embodiment, the software is implemented by logic in a Field Programmable Gate Array (FPGA). The demultiplexer 108 may also be configured in accordance with the determined frame mapping, or to some other mapping, as input by a user.

The demultiplexer 108 may be, for example, a SONET/SDH demultiplexer.

The network analyzer 100 is connected to a PC 112 that runs analysis software, and a disk server 114, used for storing large amounts of captured data. Though the connections between the network analyzer 100 and the PC 112, and the network analyzer 100 and the disk server 114, are shown as being direct in FIG. 1, such connections can also be accomplished via the network 104.

According to one embodiment, the network analyzer 100 has a user interface. In the embodiment shown in FIG. 1, the user interface is shown as a button 116. Engaging the user interface (pushing the button 116, for example) may initiate the determination of the frame mapping and the automatic configuration of the demultiplexer 108. According to one embodiment, the button 116 may be implemented on the PC 112 rather than on the network analyzer 100. According to another embodiment, the button 116 may be implemented on both the PC 112 and the network analyzer 100. While in FIG. 1, the user interface is depicted as the button 116, there are many different kinds of user interfaces, for example, a flip switch, a rotatable knob, an IR signal transmitter and receiver combination, a button on a computer keyboard, a graphical user interface on a display, a combination of a compuer pointing device and a graphical user interface, a touch-screen, or a key and key-slot combination. The present invention is not limited to any specific user interface.

Additionally, in the embodiment shown in FIG. 1, the network analyzer 100 has a graphical user interface (GUI) 118. The GUI 118 may display a result of the determination of the frame mapping, for example, “Not Configured,” “E1,” or “DS1.” The GUI 118 may also display a status of the automatic configuration of the demultiplexer, for example, “In Progress,” or “Complete.” According to one embodiment, the GUI 118 may be implemented on the PC 112 rather than on the network analyzer 100. According to another embodiment, the GUI 118 may be implemented on both the PC 112 and the network analyzer 100.

FIG. 1 also illustrates a network analysis system 119. In the embodiment depicted in FIG. 1, the network analyzer, the PC 112, and the disk server 114 are part of the network analysis system 119. According to one embodiment of the network analysis system 119, the button 116 is implemented on the PC 112 rather than on the network analyzer 100. According to one embodiment, the PC 112, the network analyzer 100, and an additional PC are part of the network analysis system 119. In such an embodiment, the additional PC may control the PC 112.

Herein, PC is used as an abbreviation for a computer. There are many different kinds of computers, for example, a personal computer, a server, or a terminal, any of which may include an output device, such as a monitor, and an input device, such as a keyboard, or a mouse. The present invention, however, is not limited to any specific computer, input device, or output device.

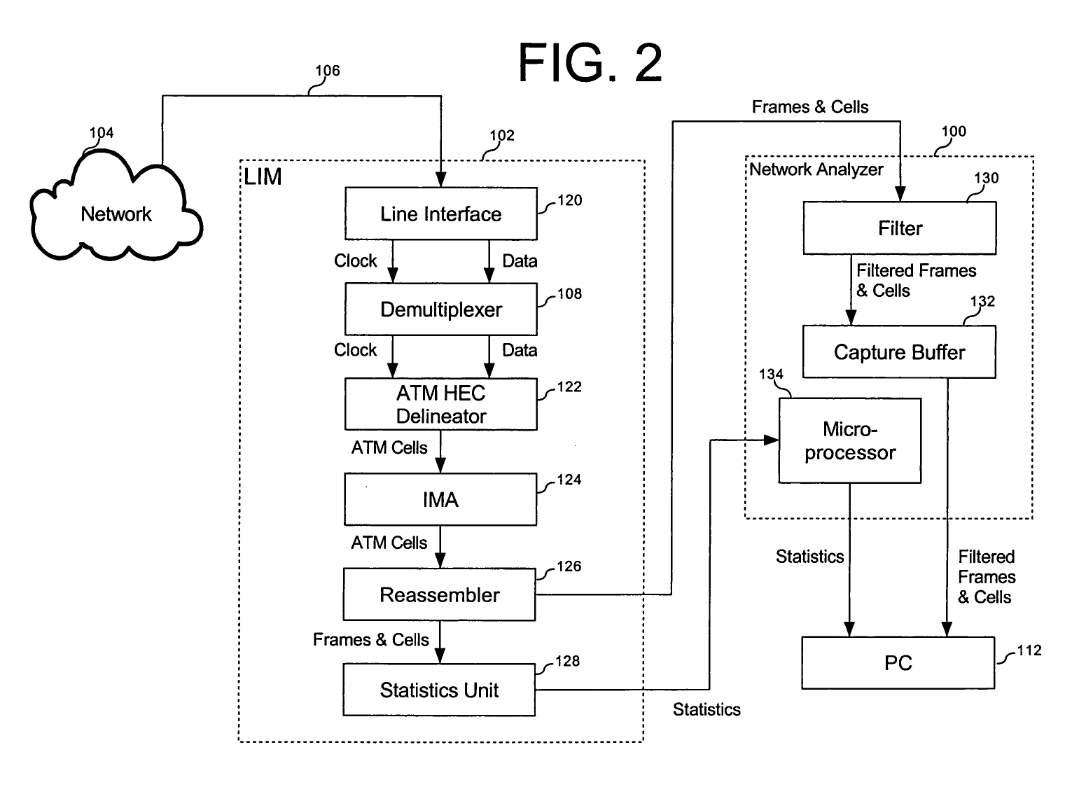

FIG. 2 illustrates a logical structure of an asynchronous transfer mode (ATM) embodiment of the present invention. In FIG. 2, the LIM 102 receives the input signal 106 from the network 104 at a line interface 120. The line interface 120 is connected to the demultiplexer 108 by both clock and data lines. Similarly, the demultiplexer 108 is connected to an ATM HEC delineator 122 by both clock and data lines. The ATM HEC delineator 122 extracts 53 byte cells based on header error correction bytes of an ATM cell header, and conveys ATM cells to an IMA (Inverse Multiplexing over ATM) 124. The IMA 124 conveys ATM cells to a reassembler 126, which performs ML2 and ML5 reassembly. The reassembler 126 conveys frames and cells to both a statistics unit 128 and to a filter 130 in the network analyzer 100. The filter 130 conveys filtered frames and cells to a capture buffer 132, which conveys filter frames and cells to the PC 112. The statistics unit 128 conveys statistics to a microprocessor 134, which conveys statistics to the PC 112.

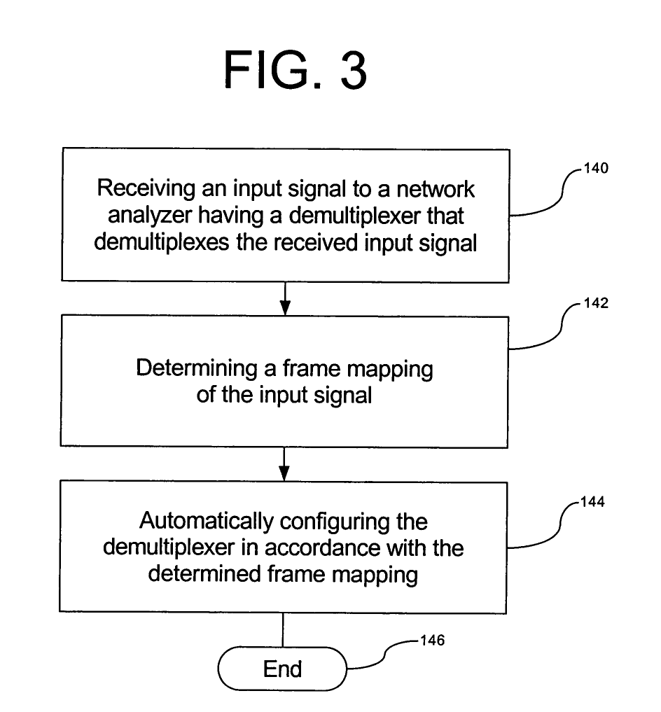

FIG. 3 illustrates a flowchart of a method according to an embodiment of the present invention. The method illustrated in FIG. 3 can be implemented in an environment such as the environment shown in FIG. 1. For example, one implementation may be a mixture of FPGA logic and software for a network analyzer, such as the network analyzer 100 shown in FIG. 1. In one implementation, such FPGA logic and software may be embodied in a determination unit, such as the determination unit 110 shown in FIG. 1.

In FIG. 3, in operation 140, an input signal 106 is received in a network analyzer 100 having a demultiplexer 108 that demultiplexes the received input signal 106.

Next, in operation 142, the determination unit 110 determines a frame mapping of the input signal 106. There are many different manners of mapping a frame of the input signal 106, and the present invention is not limited to any specific manner of mapping the input signal 106. Then, in operation 144, the determination unit 110 automatically configures the demultiplexer 108 is in accordance with the determined frame mapping, and the method is completed 146. There are many different manners of automatically configuring the demultiplexer 108 in accordance with the determined frame mapping, and the present invention is not limited to any specific manner of automatically configuring the demultiplexer 108.

According to one embodiment, determining the frame mapping of the input signal 106 is a combination of examining signal labels of the input signal 106, and automated trial and error.

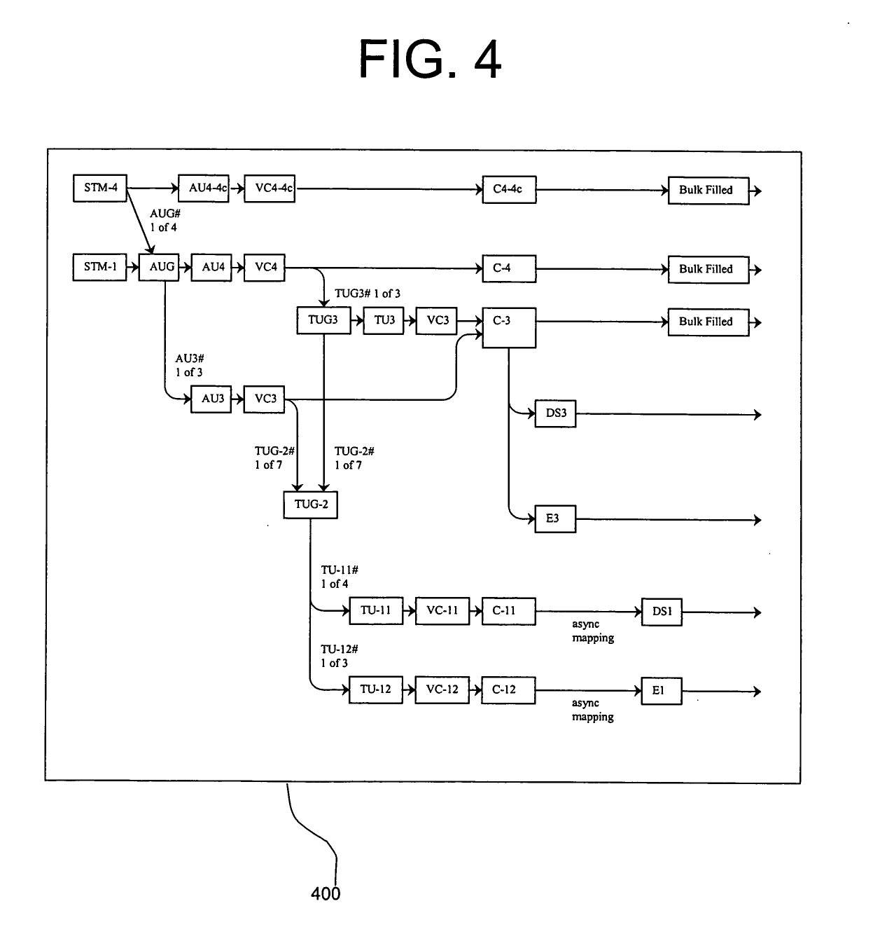

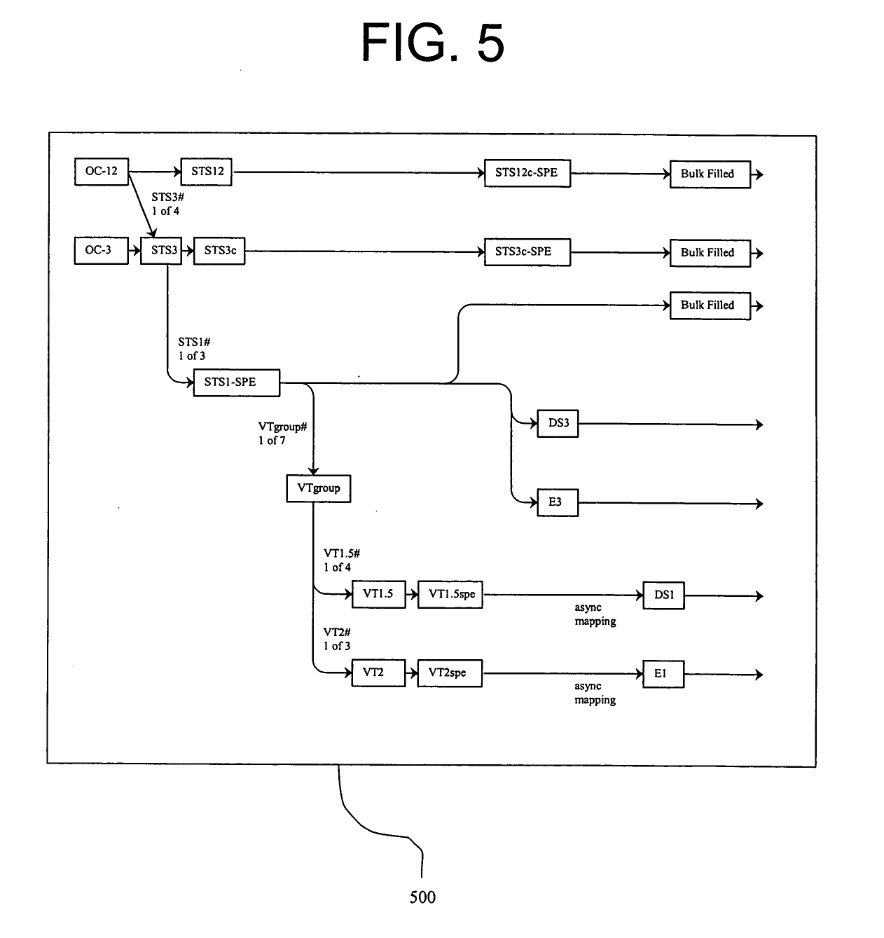

FIG. 4 illustrates a rocket diagram 400 for an SDH frame. And FIG. 5 illustrates a rocket diagram 500 for a SONET frame. The rocket diagrams 400 and 500 show the many different ways a SONET/SDH frame can be internally mapped. The demultiplexer 108 operates left to right on the rocket diagrams. For example, in FIG. 4, an STM-1/STM-4 framer looks for an F628 pattern to find a 125 μs frame called an administative unit group (AUG), or looks for an AU4c. An AUG, for example, is a group of 1 or more administrative units (AUs) that have been interleaved. If it is determined that an AUG is present, the AUG is then de-interleaved.

An AU is a virtual container (VC) that has some overhead attached to it. The overhead contains a pointer that points to a location of a start of the VC. This is called pointer processing. The VC is an approximately 125 μs frame within the AU, which is also repetitive at 125 μs.

The VC contains some overhead bytes. If these are removed, what results is either a container Cx-x or a tributary unit group (TUG). A TUG may have a number of tributary units (TUs) interleaved. A TU is like an AU, but AU's are different, in that AUs are like lower rate versions of an SDH frame. In a TU, the overhead has a pointer that points to a VC, which is also an approximately 125 μs repetetive frame.

If some more overhead is removed from the VC and you end up with a C-3, a C-11 or C-12. Within a C-11, a DS1 can be embedded using a stuffing method. Similarly, within a C-12 an E1 can be embedded using a stuffing method.

As a further example, as shown in FIG. 4, a frame mapped as an STM-1 (155.52 Mbit/sec) can be structured as one VC4 or 3 VC3 mappings. If the frame mapping was determined to be 3 VC3 mappings, then one VC3 could be a C3 mapped, another VC3 could be C11 mapped, and the remaining VC3 could be C12 mapped. Or, all three VC3 mappings could be C3 mapped.

Further explanation of the illustrations of the possible internal mappings of SONET/SDH frames will be omitted for brevity.

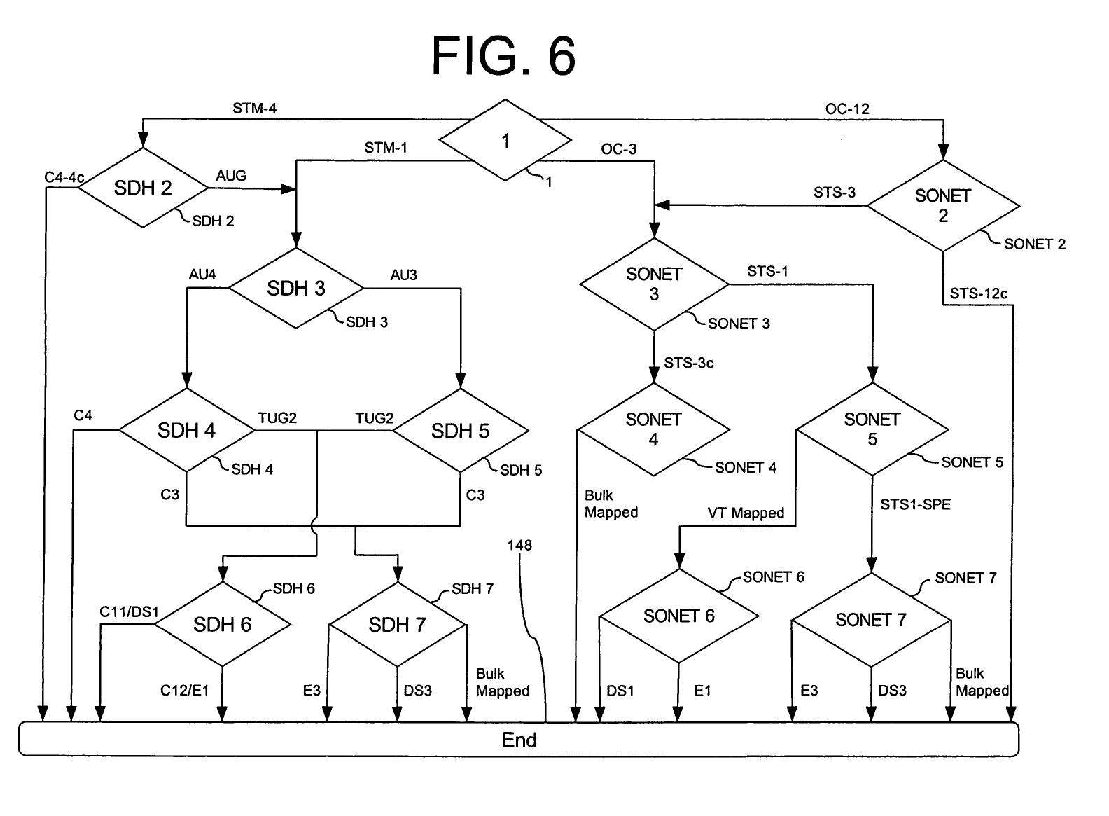

FIG. 6 illustrates a flowchart of an embodiment of operation 142, shown in FIG. 3, namely, determining a frame mapping of the input signal 106. In FIG. 6, in operation 1, the determination unit 110 determines whether the frame mapping is STM-1, STM-4, OC-3, or OC-12. If the frame mapping is determined to be STM-4, then in operation SDH 2, the determination unit 110 determines whether the frame mapping is C4-4c or AUG. If the frame mapping is determined to be C4-4c, then operation 142 ends 148, and the demultiplexer 108 is automatically configured in accordance with the determined frame mapping 144.

If instead, in operation SDH 2, the frame mapping is determined to be AUG, or the frame mapping is determined to be STM-1 in operation 1, then in operation SDH 3, the determination unit 110 determines whether the frame mapping is AU4 or AU3. If the frame mapping is determined to be AU4, then for each AU4, the determination unit 110 determines whether the frame mapping is C4, C3, or TUG-2, in operation SDH 4.

If the frame mapping is determined to be C4, then operation 142 ends 148, and the demultiplexer 108 is automatically configured in accordance with the determined frame mapping 144.

If the frame mapping is determined to be AU3 in operation SDH3, then for each AU3, the determination unit 110 determines whether the frame mapping is C3 or TUG-2 in operation SDH 5.

If the frame mapping is determined to be TUG2 in either operation SDH 4 or operation SDH 5, then in operation SDH 6, the determination unit 110 determines whether the frame mapping is DS1 or E1. And if, in either operation SDH 4 or operation SDH 5, it is determined that the frame mapping is C3, then in operation SDH 7, the determination unit 110 determines whether the frame mapping is DS3, E3, or bulk mapped.

If the frame mapping is determined to be DS1 or E1 in operation SDH 6, or the frame mapping is determined to be DS3, E3, or bulk mapped in operation SDH 7, then operation 142 ends 148, and the demultiplexer 108 is automatically configured in accordance with the determined frame mapping 144.

Looking back at operation 1, if the frame mapping is determined to be OC-12, then in operation SONET 2, the determination unit 110 determines whether the frame mapping is STS-12c or STS-3. If the frame mapping is determined to be STS-12c, then operation 142 ends 148, and the demultiplexer 108 is automatically configured in accordance with the determined frame mapping 144. But if the frame mapping is determined to be STS-3 in operation SONET 2, or the frame mapping is determined to be OC-3 in operation 1, then the determination unit 110 determines whether the frame mapping is STS-3c or STS-1 in operation SONET 3.

If the frame mapping is determined to be STS-3c, the determination unit 110 determines that the fame mapping is bulk mapped in operation SONET 4. Then, operation 142 ends 148, and the demultiplexer 108 is automatically configured in accordance with the determined frame mapping 144. But if the frame mapping is determined to be STS-1, then for each STS-1, the determination unit 110 determines whether the frame mapping is VT or STS1-SPE in operation SONET 5.

If the frame mapping is determined to be VT, the determination unit 110 determines whether the frame mapping is VT1.5/DS1 or VT2/E1 in operation SONET 6. And if the frame mapping is determined to be STS1-SPE, the determination unit 110 determines whether the frame mapping is DS3, E3, or bulk mapped in operation SONET 7.

If the frame mapping is determined to be DS1 or E1 in operation SONET 6, or the frame mapping is determined to be DS3, E3, or bulk mapped in operation SONET 7, then operation 142 ends 148, and the demultiplexer 108 is automatically configured in accordance with the determined frame mapping 144.

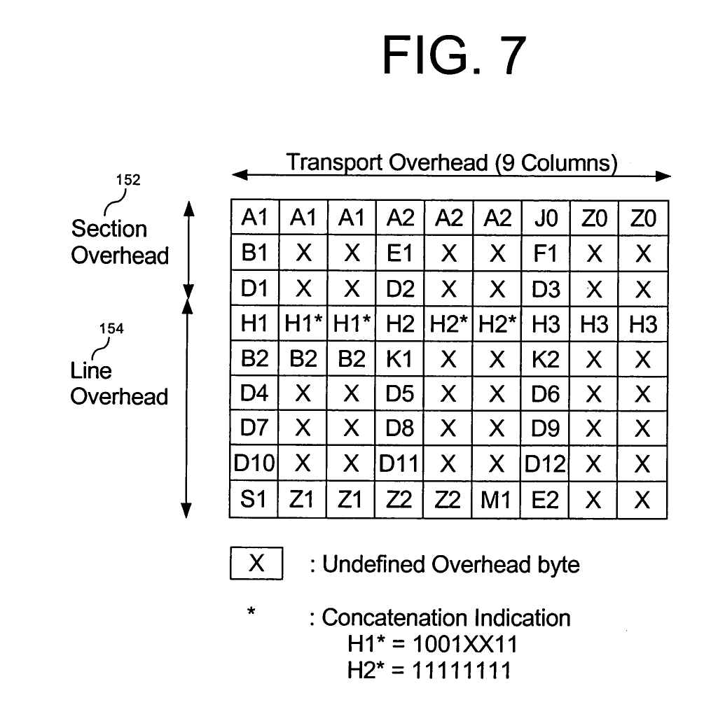

FIG. 7 illustrates an example of a transport overhead of a frame. In FIG. 7, nine columns of transport overhead 150 are divided into three rows of section overhead 152 and six rows of line overhead 154. Each cell in the illustrated 9×9 matrix represents an overhead byte in the transport overhead 150. An “X” in a cell indicates that the particular overhead byte is undefined. And if certain values appear in “*” marked cells, then the frame format is of a concatenated type. It should be noted that the transport overhead 150 is shown merely as an example for reference, and the invention is not limited to the transport overhead 150 shown in FIG. 7.

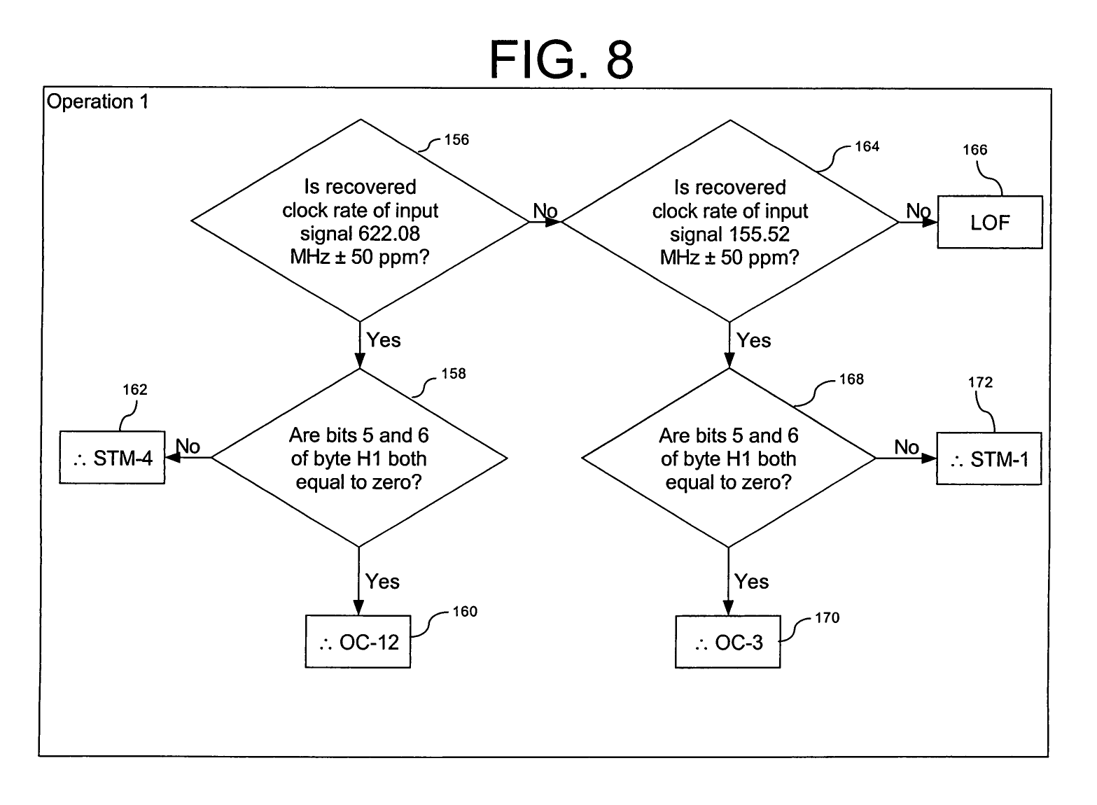

FIG. 8 is a flowchart illustrating an embodiment of operation 1 of FIG. 6. Referring to FIG. 6, in operation 156, the determination unit 110 determines whether a recovered clock rate of the input signal 106 is 622.08 MHz±50 parts per million (ppm). If so, the determination unit 110 determines whether bits 5 and 6 of byte H1 of a given frame are both equal to zero in operation 158. If bits 5 and 6 of byte H1 are both equal to zero in operation 158, the determination unit 110 determines that the frame mapping is OC-12 in operation 160, and if not, the determination unit 110 determines that the frame mapping is STM-4 in operation 162.

If the determination unit 110 determines that the recovered clock rate of the input signal 106 is not 622.08 MHz±50 ppm, then the determination unit 110 determines whether the recovered clock rate of the input signal 106 is 155.52 MHz±50 ppm in operation 164. If not, then the determination unit 110 reports a loss of frame (LOF) to the GUI 118 in operation 166. If it is determined that the recovered clock rate of the input signal 106 is 155.52 MHz±50 parts per million, the determination unit 110 determines whether bits 5 and 6 of byte H1 of a given frame are both equal to zero in operation 168. If bits 5 and 6 of byte H1 are both equal to zero in operation 168, the determination unit 110 determines that the frame mapping is OC-3 in operation 170, and if not, the determination unit 110 determines that the frame mapping is STM-1 in operation 172.

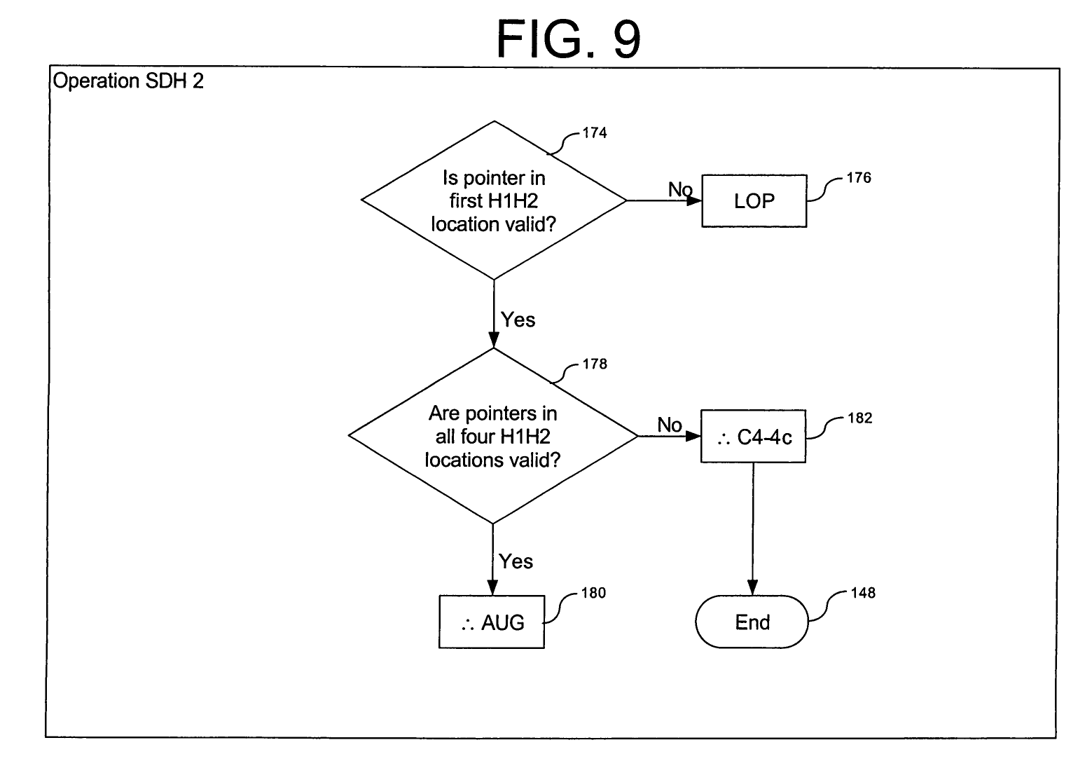

FIG. 9 is a flowchart illustrating an embodiment of operation SDH 2 of FIG. 6. Referring to FIG. 9, in operation 174, the determination unit 110 determines whether a pointer in a first H1H2 location is valid. Looking, for example, at the H1 and H2 bytes that are next to each other in FIG. 7, the first four bits are called a new data flag (NDF). And the last ten bits are a pointer. In general, for a pointer to be valid, the NDF must have a fixed value, for example, 6 (or 0110 in binary), and the pointer can only have a value between 0 and 782. Additionally, these conditions must be static for three consecutive frames.

If the pointer in the first H1H2 location is not valid, the determination unit 110 reports a loss of pointer (LOP) to the GUI 118 in operation 176. If the pointer in the first H1H2 location is valid, the determination unit 110 determines whether pointers in all four H1H2 locations are valid in operation 178. If the pointers in all four H1H2 locations are valid, then the determination unit 110 determines that the frame mapping is AUG (operation 180), and if not, the determination unit 110 determines that the frame mapping is C4-4c (operation 182).

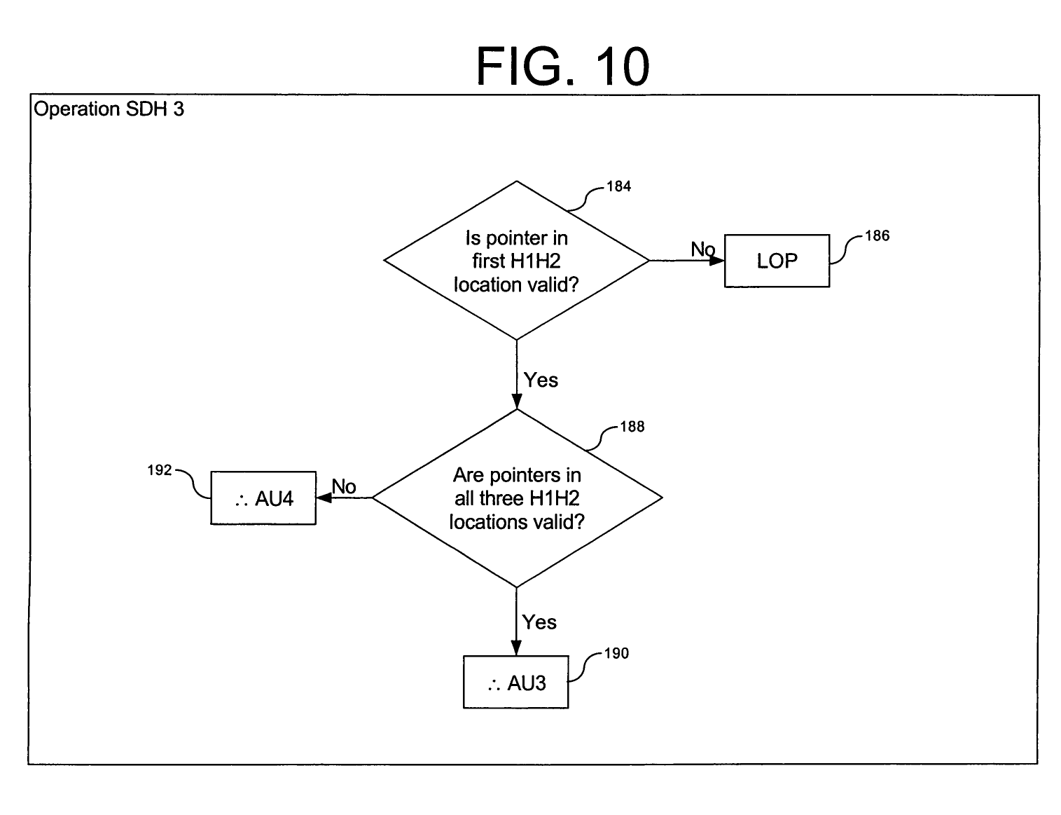

FIG. 10 is a flowchart illustrating an embodiment of operation SDH 3 of FIG. 6. Referring to FIG. 10, in operation 184, the determination unit 110 determines whether a pointer in a first H1H2 location is valid. If the pointer in the first H1H2 location is not determined to be valid, the determination unit 110 reports an LOP to the GUI 118 in operation 186. If the pointer in the first H1H2 location is valid, the determination unit 110 determines whether pointers in all three H1H2 locations are valid in operation 188. If the pointers in all three H1H2 locations are valid, then the determination unit 110 determines that the frame mapping is AU3 (operation 190), and if not, the determination unit 110 determines that the frame mapping is AU4 (operation 192).

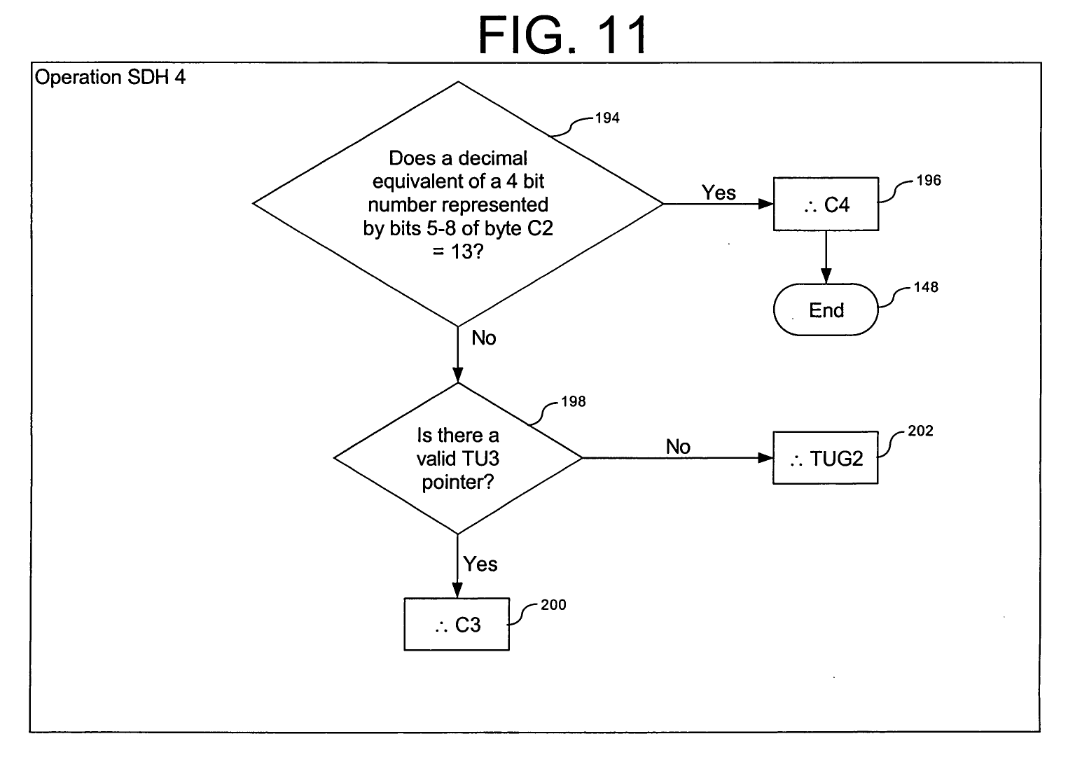

FIG. 11 is a flowchart illustrating an embodiment of operation SDH 4 of FIG. 6. Referring to FIG. 11, in operation 194, the determination unit 110 determines whether a decimal equivalent of a 4 bit number represented by bits 5 through 8 of byte C2 of a given frame equals 13. If the decimal equivalent of the 4 bit number represented by bits 5 through 8 of byte C2 equal 13, the determination unit 110 determines that the frame mapping is C4 in operation 196, and if not, the determination unit 110 determines whether a TU3 pointer is valid in operation 198. If the TU3 pointer is determined to be valid, the determination unit 110 determines that the frame mapping is C3 in operation 200, and if not, the determination unit 110 determines that the frame mapping is TUG2 in operation 202.

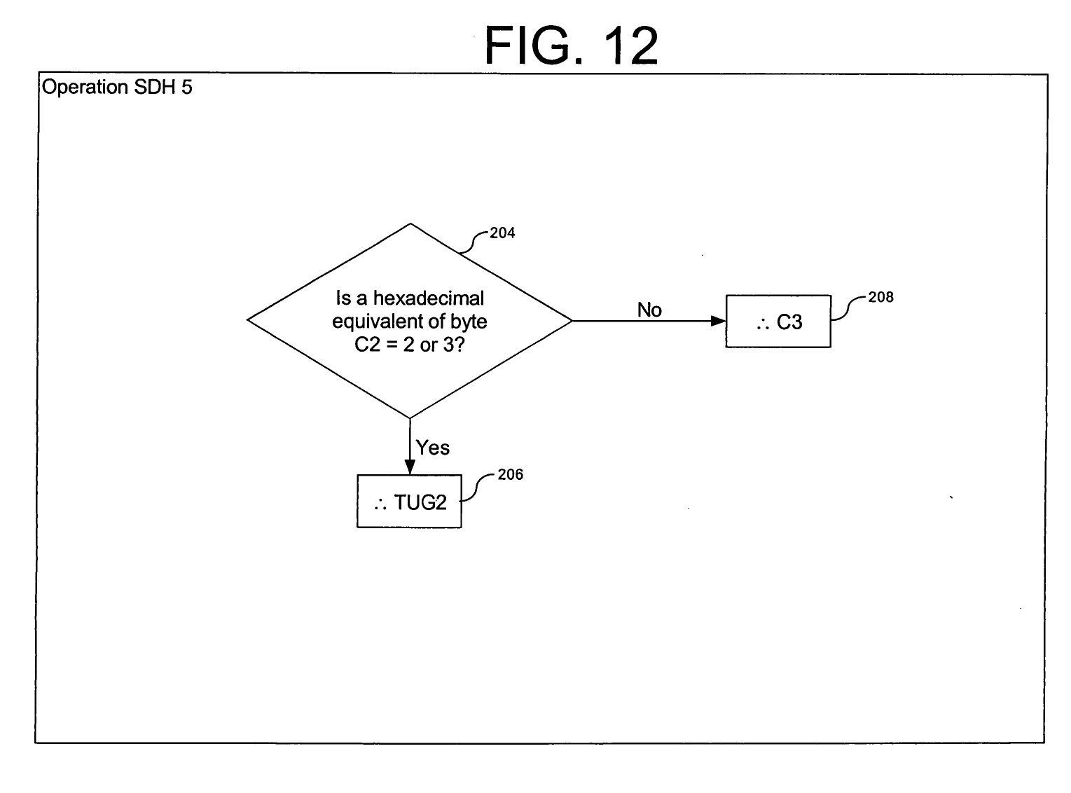

FIG. 12 is a flowchart illustrating an embodiment of operation SDH 5 of FIG. 6. Referring to FIG. 12, in operation 204, the determination unit 110 determines whether a hexadecimal equivalent of byte C2 of a given frame equals 2 or 3. If the hexadecimal equivalent of byte C2 equals 2 or 3, then the determination unit 110 determines that that the frame mapping is TUG2 in operation 206, and if not, the determination unit 110 determines that the frame mapping is C3 in operation 208.

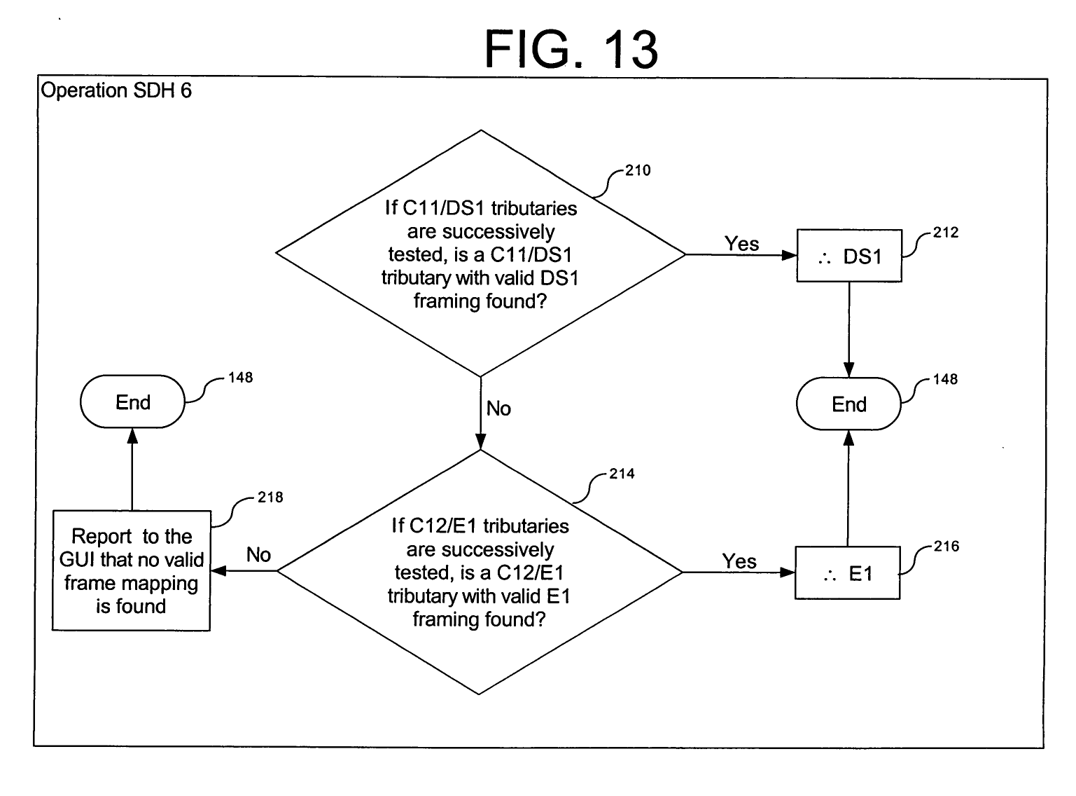

FIG. 13 is a flowchart illustrating an embodiment of operation SDH 6 of FIG. 6. Referring to FIG. 13, in operation 210, the determination unit 110 successively tests C11/DS1 tributaries until a C11/DS1 tributary with valid DS1 framing is found. If a C11/DS1 tributary with valid DS1 framing is found, the determination unit 110 determines that the frame mapping is DS1 in operation 212. If no C11/DS1 tributary with valid DS1 framing is found, the determination unit 110 successively tests C12/E1 tributaries until a C12/E1 tributary with valid E1 framing is found in operation 214. If a C12/E1 tributary with valid E1 framing is found, the determination unit 110 determines that the frame mapping is E1 in operation 216. If no C12/E1 tributary with valid E1 framing is found, the determination unit 110 reports to the GUI 118 that no valid frame mapping is found in operation 218.

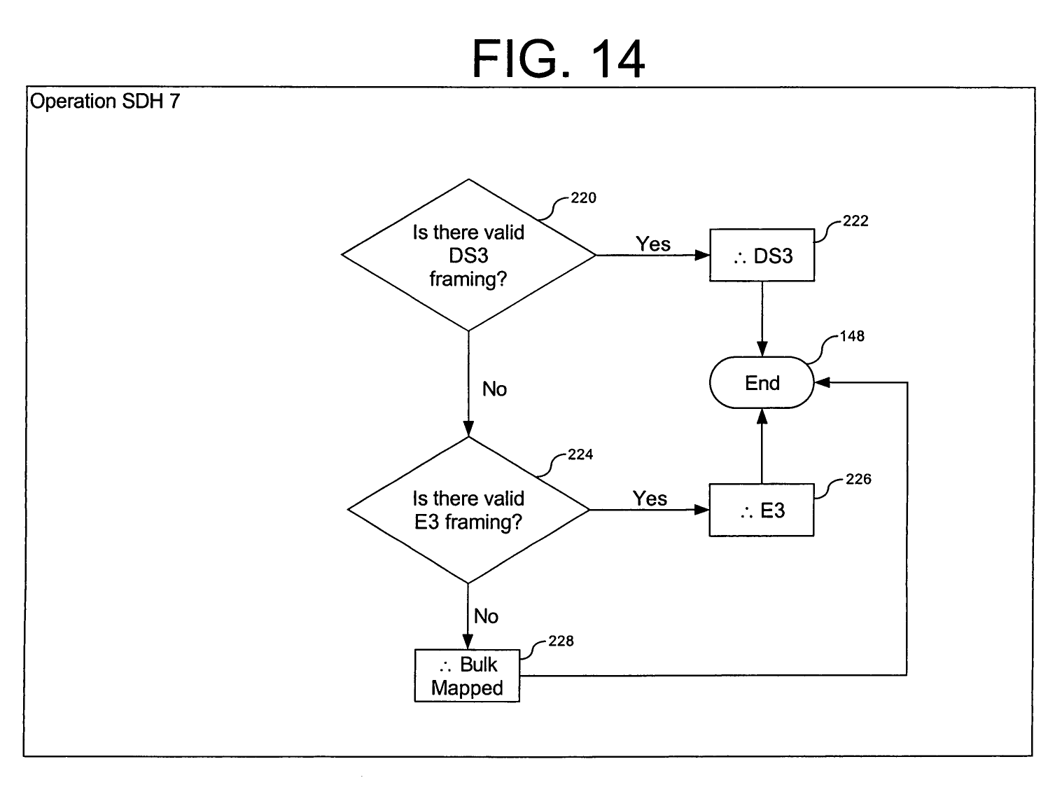

FIG. 14 is a flowchart illustrating an embodiment of operation SDH 7 of FIG. 6. Referring to FIG. 14, in operation 220, the determination unit 110 determines whether a given frame has valid DS3 framing. If valid DS3 framing is found, the determination unit 110 determines that the frame mapping is DS3 in operation 222. If no valid DS3 framing is found, the determination unit 110 determines whether the given frame has valid E3 framing in operation 224. If valid E3 framing is found, the determination unit 110 determines that the frame mapping is E3 in operation 226. If no valid E3 framing is found, the determination unit 110 determines that the frame mapping is bulk mapped in operation 228.

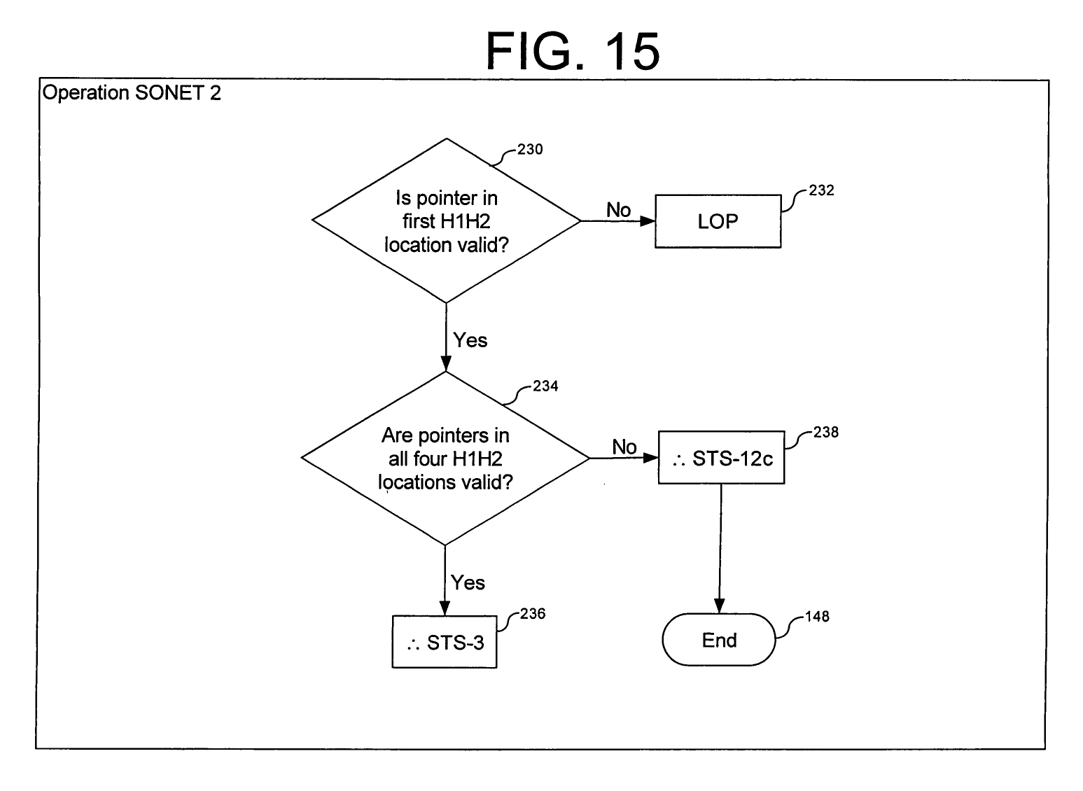

FIG. 15 is a flowchart illustrating an embodiment of operation SONET 2 of FIG. 6. Referring to FIG. 15, in operation 230, the determination unit 110 determines whether a pointer in a first H1H2 location is valid. If the pointer in the first H1H2 location is not valid, the determination unit 110 reports a loss of pointer (LOP) to the GUI 118 in operation 232. If the pointer in the first H1H2 location is valid, the determination unit 110 determines whether pointers in all four H1H2 locations are valid in operation 234. If the pointers in all four H1H2 locations are valid, then the determination unit 110 determines that the frame mapping is STS-3 (operation 236), and if not, the determination unit 110 determines that the frame mapping is STS-12c (operation 238).

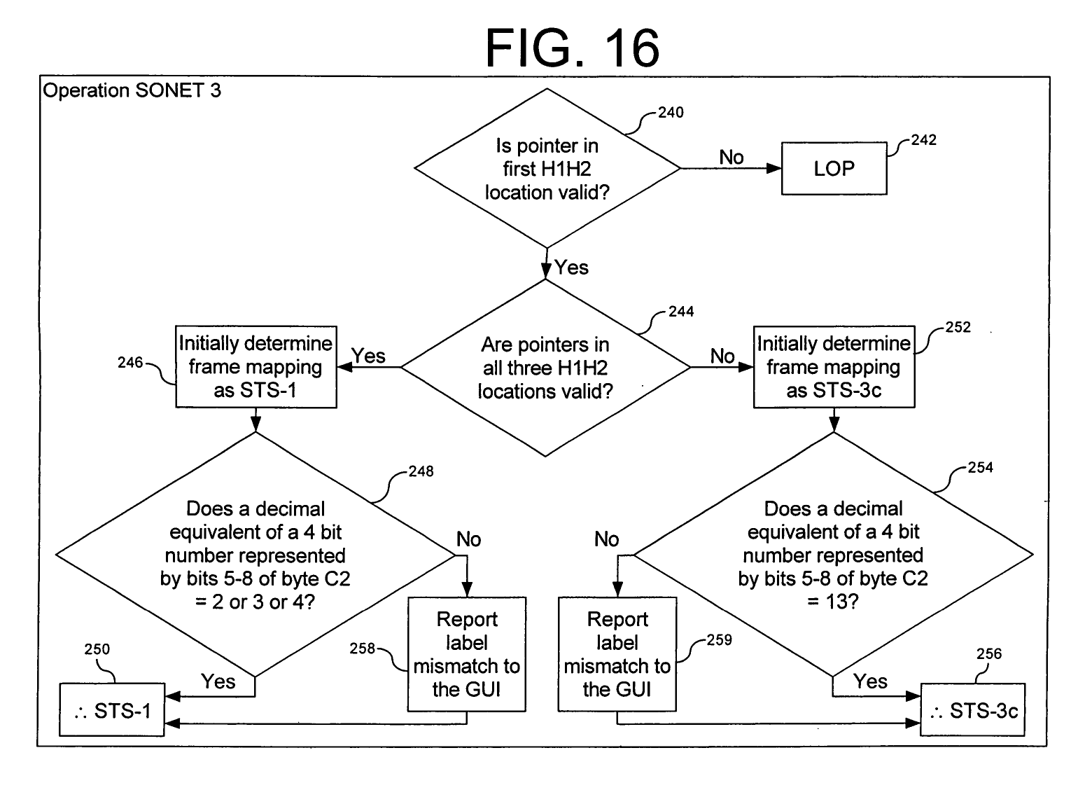

FIG. 16 is a flowchart illustrating an embodiment of operation SONET 3 of FIG. 6. Referring to FIG. 16, in operation 240, the determination unit 110 determines whether a pointer in a first H1H2 location is valid. If the pointer in the first H1H2 location is not valid, then the determination unit 110 reports an LOP to the GUI 118 in operation 242. If the pointer in the first H1H2 location is valid, then in operation 244, the determination unit 110 determines whether pointers in all three H1H2 locations are valid. If the pointers in all three H1H2 locations are valid, then in operation 246, the determination unit 110 initially determines that the frame mapping is STS-1.

Subsequently, in operation 248, the determination unit 110 tests whether a label mismatch is present by determining whether a decimal equivalent of a 4 bit number represented by bits 5 through 8 of byte C2 of a given frame equals 2 or 3 or 4. If the decimal equivalent of the 4 bit number represented by bits 5 through 8 of byte C2 equals 2 or 3 or 4, the determination unit 110 determines that there is no label mismatch resulting from the determination of mapping to be STS-1, and finally determines that the frame mapping is STS-1 in operation 250.

In operation 244, if the pointers in all three H1H2 locations are not valid, then in operation 252, the determination unit 110 initially determines that the frame mapping is STS-3c. Subsequently, in operation 254, the determination unit 110 tests whether a label mismatch is present by determining whether the decimal equivalent of the 4 bit number represented by bits 5 through 8 of byte C2 of the given frame equals 13. If the decimal equivalent of the 4 bit number represented by bits 5 through 8 of byte C2 equals 13, the determination unit 110 determines that there is no label mismatch resulting from the determination of mapping to be STS-1, and finally determines that the frame mapping is STS-3c in operation 256.

If the decimal equivalent of the 4 bit number represented by bits 5 through 8 of byte C2 does not equal 2 or 3 or 4 in operation 248, the determination unit 110 reports a label mismatch to the GUI 118 in operation 258, and then finally determines that the frame mapping is STS-1 in operation 250. Similarly, if the decimal equivalent of the 4 bit number represented by bits 5 through 8 of byte C2 does not equal 13 in operation 254, the determination unit 110 reports a label mismatch to the GUI 118 in operation 259, and then finally determines that the frame mapping is STS-3c in operation 256.

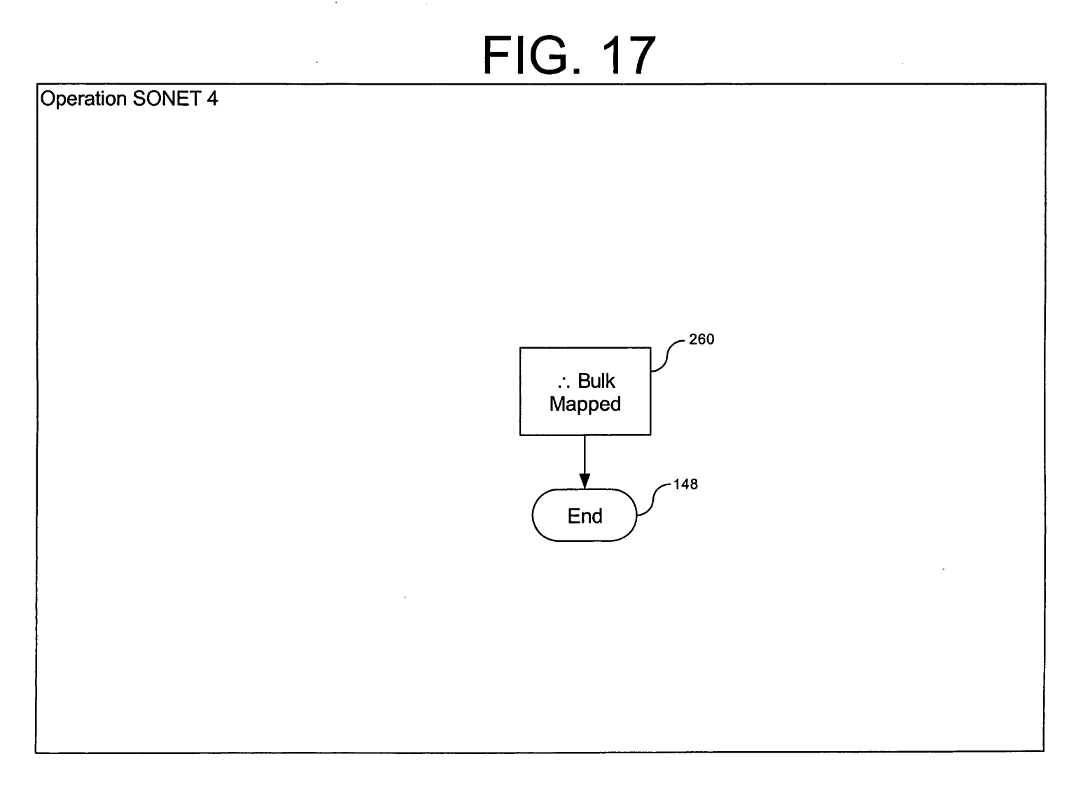

FIG. 17 is a flowchart illustrating an embodiment of operation SONET 4 of FIG. 6. Referring to FIG. 17, in operation 260, the determination unit 110 determines that the frame mapping is bulk mapped.

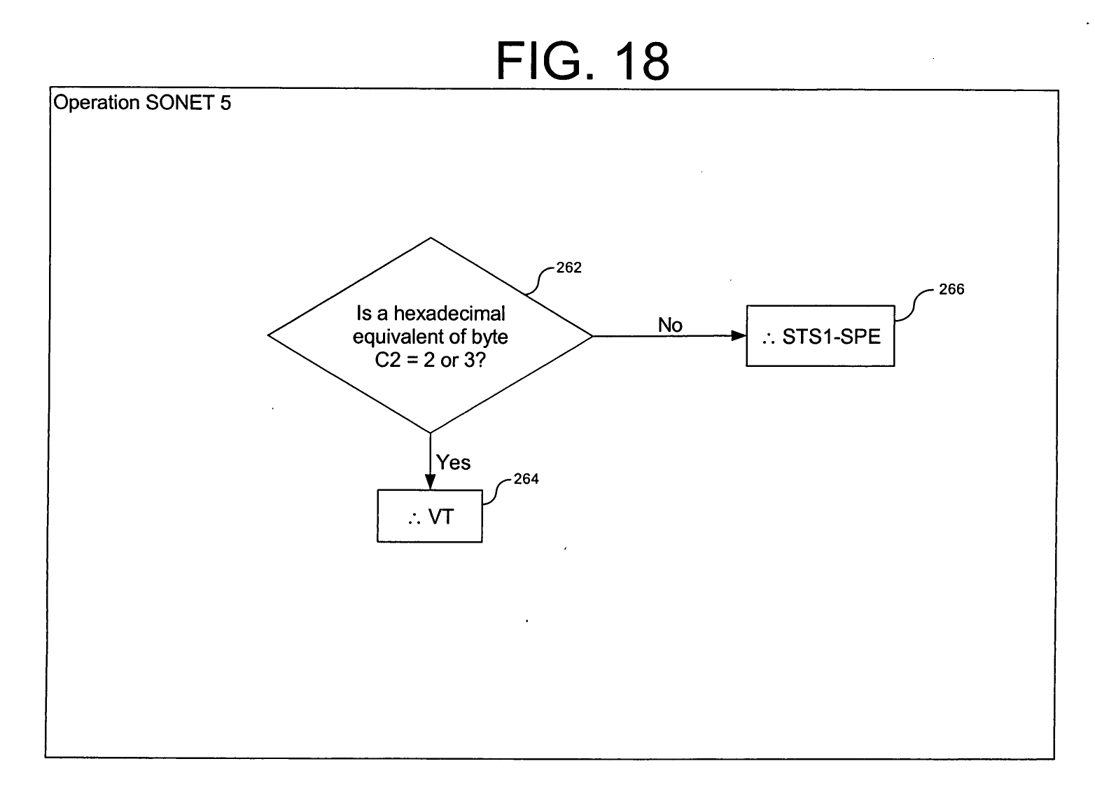

FIG. 18 is a flowchart illustrating an embodiment of operation SONET 5 of FIG. 6. Referring to FIG. 18, in operation 262, the determination unit 110 determines whether a hexadecimal equivalent of byte C2 of a given frame equals 2 or 3. If the hexadecimal equivalent of byte C2 equals 2 or 3, the determination unit 110 determines that the frame mapping is VT in operation 264, and if not, the determination unit 110 determines that the frame mapping is STS1-SPE in operation 266.

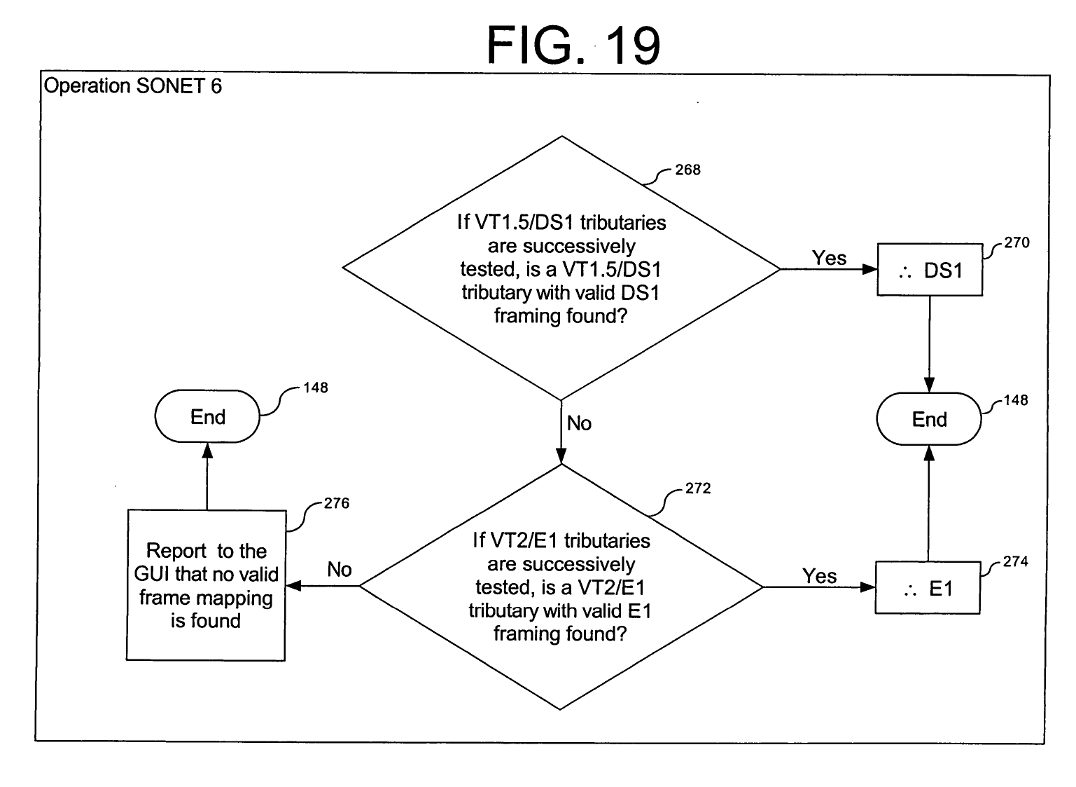

FIG. 19 is a flowchart illustrating an embodiment of operation SONET 6 of FIG. 6. Referring to FIG. 19, in operation 268, the determination unit 110 successively tests VT1.5/DS1 tributaries until a VT1.5/DS1 tributary with valid DS1 framing is found. In operation 270, if a VT1.5/DS1 tributary with valid DS1 framing is found, the determination unit 110 determines that the frame mapping is DS1.

If no VT1.5/DS1 tributary with valid DS1 framing is found, then in operation 272, the determination unit 110 successively tests VT2/E1 tributaries until a VT2/E1 tributary with valid E1 framing is found. If a VT2/E1 tributary with valid 1 framing is found, the determination unit 110 determines that the frame mapping is E1 in operation 274. But if no VT2/E1 tributary with valid E1 framing is found, in operation 276, the determination unit 110 reports to the GUI 118 that no valid frame mapping is found.

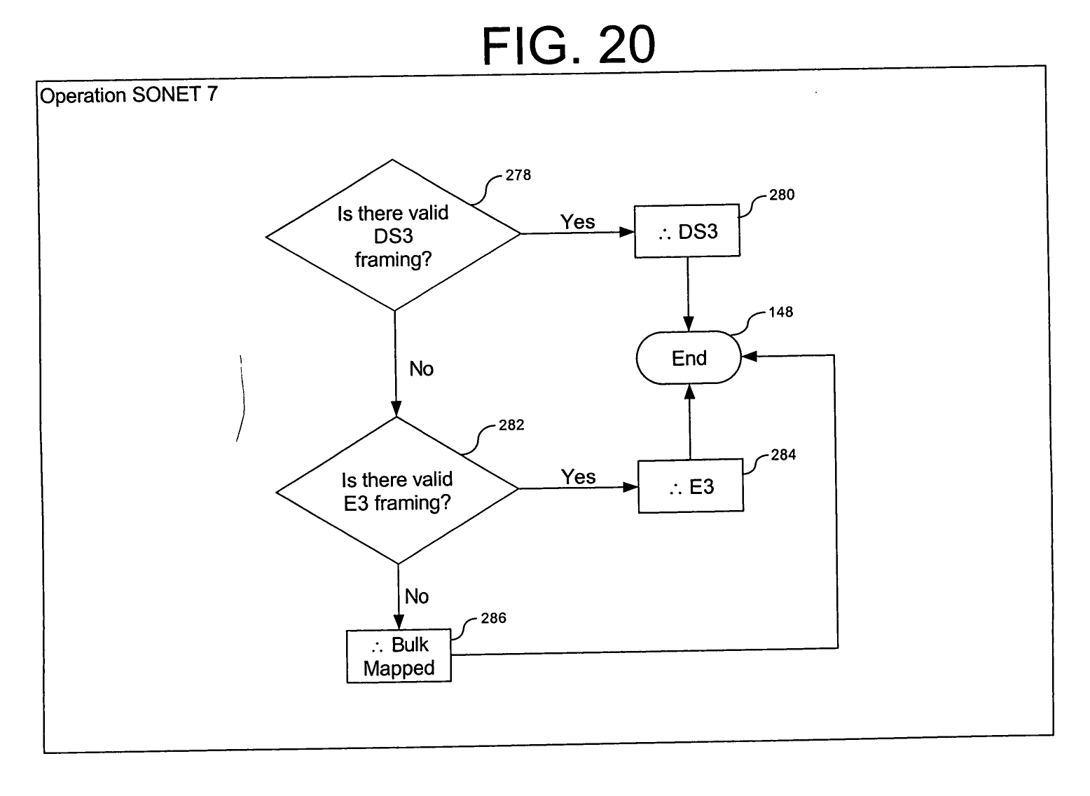

FIG. 20 is a flowchart illustrating an embodiment of operation SONET 7 of FIG. 6. Referring to FIG. 20, in operation 278, the determination unit 110 determines whether a given frame has valid DS3 framing. If there is valid DS3 framing, the determination unit 110 determines that the frame mapping is DS3 in operation 280, but if not, the determination unit 110 determines whether the given frame has valid E3 framing in operation 282. If there is valid E3 framing, the determination unit 110 determines that the frame mapping is E3 in operation 284. But if there is no valid E3 framing the determination unit 110 determines that the frame mapping is bulk mapped in operation 286.

Various network analyzers are described herein, such as the distributed network analyzer. The present invention in not limited to any specific network analyzer, and other network analyzers can be used. Similarly, various demultiplexers are described herein, such as the SONET/SDH demultiplexer. The present invention in not limited to any specific demultiplexer, and other demultiplexers can be used.

The present invention may be implemented by a method, an apparatus, and a system. When the present invention is implemented in software, the present invention can be embodied as code segments for executing necessary operations. Programs or code segments may be stored in a processor readable medium or may be transmitted through computer data signals mixed with carrier waves in a transmission medium and/or communication network. The processor readable medium is any medium that can store or transmit data. Examples of the processor readable medium include electronic circuits, semiconductor memory devices, ROM, flash memory, erasable ROM, floppy discs, optical discs, hard discs, optical fibre media, and radio frequency (RF) networks. Examples of the computer data signals include any type of signals that can be transmitted through transmission media such as electronic network channels, optical fibre, air, electric fields, and RF networks.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method, comprising:
receiving an input signal to a network analyzer having a demultiplexer that demultiplexes the received input signal;
determining a frame mapping of the input signal; and
automatically configuring the demultiplexer in accordance with the determined frame mapping.

2. The method according to claim 1, wherein the determining the frame mapping of the input signal comprises:
a combination of examining signal labels of the received input signal, and automated trial and error.

3. The method according to claim 1, wherein the demultiplexer is a SONET/SDH demultiplexer.

4. The method according to claim 1, wherein the network analyzer has a graphical user interface (GUI), and the method further comprises:
displaying a result of the determining of the frame mapping of the input signal in the GUI.

5. The method according to claim 4, further comprising:
in the GUI, displaying a status of the automatic configuring of the demultiplexer.

6. The method according to claim 1, wherein the network analyzer has a graphical user interface (GUI), and the determining the frame mapping of the input signal comprises:
determining whether the frame mapping is STM-1, STM-4, OC-3, or OC-12;
if the frame mapping is determined to be STM-1 or STM-4,
if the frame mapping is determined to be STM-4, determining whether the frame mapping is C4-4c or AUG,
if the frame mapping is determined to be C4-4c, automatically configuring the demultiplexer in accordance with the determined frame mapping,
if the frame mapping is determined to be STM-1 or AUG, determining whether the frame mapping is AU4 or AU3,
if the frame mapping is determined to be AU4, then for each AU4, determining whether the frame mapping is C4, C3, or TUG-2,
if the frame mapping is determined to be C4, automatically configuring the demultiplexer in accordance with the determined frame mapping,
if the frame mapping is determined to be AU3, then for each AU3, determining whether the frame mapping is C3 or TUG-2,
if the frame mapping is determined to be TUG-2, determining whether the frame mapping is DS1 or E1,
if the frame mapping is determined to be DS1, automatically configuring the demultiplexer in accordance with the determined frame mapping, else
if the frame mapping is determined to be E1, automatically configuring the demultiplexer in accordance with the determined frame mapping, else
reporting that no valid frame mapping is found to the GUI,
if the frame mapping is determined to be C3, determining whether the frame mapping is DS3, E3, or bulk mapped,
if the frame mapping is determined to be DS3, automatically configuring the demultiplexer in accordance with the determined frame mapping, else
if the frame mapping is determined to be E3, automatically configuring the demultiplexer in accordance with the determined frame mapping, else
determining that the frame mapping is bulk mapped, and automatically configuring the demultiplexer in accordance with the determined frame mapping,
if the frame mapping of the input signal is determined to be OC-3 or OC-12,
if the frame mapping is determined to be OC-12, determining whether the frame mapping is STS-12c or STS-3,
if the frame mapping is determined to be STS-12c, automatically configuring the demultiplexer in accordance with the determined frame mapping,
if the frame mapping is determined to be OC-3 or STS-3, determining whether the frame mapping is STS-3c or STS-1,
if the frame mapping is determined to be STS-3c, determining that the fame mapping is bulk mapped, and automatically configuring the demultiplexer in accordance with the determined frame mapping,
if the frame mapping is determined to be STS-1, then for each STS-1, determining whether the frame mapping is VT or STS1-SPE,
if the frame mapping is determined to be VT, determining whether the frame mapping is VT1.5/DS1 or VT2/E1,
if the frame mapping is determined to be DS1, automatically configuring the demultiplexer in accordance with the determined frame mapping, else,
if the frame mapping is determined to be E1, automatically configuring the demultiplexer in accordance with the determined frame mapping, else
reporting that no valid frame mapping is found to the GUI,
if the frame mapping is determined to be STS1-SPE, determining whether the frame mapping is DS3, E3, or bulk mapped,
if the frame mapping is determined to be DS3, automatically configuring the demultiplexer in accordance with the determined frame mapping, else
if the frame mapping is determined to be DS3, automatically configuring the demultiplexer in accordance with the determined frame mapping, else
determining that the frame mapping is bulk mapped, and automatically configuring the demultiplexer in accordance with the determined frame mapping.

7. The method according to claim 6, wherein the determining whether the frame mapping is STM-1, STM-4, OC-3, or OC-12 comprises:
determining whether a recovered clock rate of the input signal is 622.08 MHz±50 parts per million,
the recovered clock rate of the input signal is 622.08 MHz±50 parts per million, determining whether bits 5 and 6 of byte H1 of a given frame are both equal to zero,
if bits 5 and 6 of byte H1 are both equal to zero, determining that the frame mapping is OC-12, and if not, determining that the frame mapping is STM-4,
if the recovered clock rate of the input signal is not 622.08 MHz±50 parts per million, determining whether the recovered clock rate of the input signal is 155.52 MHz±50 parts per million,
if the recovered clock rate of the input signal is 155.52 MHz±50 parts per million, determining whether bits 5 and 6 of byte H1 of a given frame are both equal to zero;
if bits 5 and 6 of byte H1 are both equal to zero, determining that the frame mapping is OC-3, and if not, determining that the frame mapping is STM-1, and
if the recovered clock rate of the input signal is not 155.52 MHz±50 parts per million, reporting a loss of frame to the GUI.

8. The method according to claim 6, wherein the determining whether the frame mapping is C4-4c or AUG comprises:
determining whether a pointer in a first H1H2 location is valid,
if the pointer in the first H1H2 location is not valid, reporting a loss of pointer to the GUI,
if the pointer in the first H1H2 location is valid, determining whether pointers in all four H1H2 locations are valid, and
if the pointers in all four H1H2 locations are valid, then determining that the frame mapping is AUG, else determining that the frame mapping is C4-4c.

9. The method according to claim 6, wherein the determining whether the frame mapping is AU4 or AU3, if the frame mapping is determined to be STM-4, comprises:
determining whether a pointer in a first H1H2 location is valid,
if the pointer in the first H1H2 location is not valid, reporting a loss of pointer to the GUI,
if the pointer in the first H1H2 location is valid, determining whether pointers in all three H1H2 locations are valid, and
if the pointers in all three H1H2 locations are valid, then determining that the frame mapping is AU3, else determining that the frame mapping is AU4.

10. The method according to claim 6, wherein determining whether the frame mapping is C4, C3, or TUG-2, if the frame mapping is determined to be AU4, comprises:
determining whether a decimal equivalent of a 4 bit number represented by bits 5 through 8 of byte C2 of a given frame equals 13,
if the decimal equivalent of the 4 bit number represented by bits 5 through 8 of byte C2 of the given frame equals 13, determining that the frame mapping is C4,
if the decimal equivalent of the 4 bit number represented by bits 5 through 8 of byte C2 of the given frame does not equal 13, determining whether a TU3 pointer is valid,
if the TU3 pointer is valid, determining that the frame mapping is C3, and
if the TU3 pointer is not valid, determining that the frame mapping is TUG2.

11. The method according to claim 6, wherein the determining whether the frame mapping is C3, or TUG-2, if the frame mapping is determined to be AU3, comprises
determining whether a hexadecimal equivalent of byte C2 of a given frame equals 2 or 3,
if the hexadecimal equivalent of byte C2 of the given frame equals 2 or 3, determining that the frame mapping is TUG2, and
if the hexadecimal equivalent of byte C2 of the given frame does not equal 2 or 3, determining that the frame mapping is C3.

12. The method according to claim 6, wherein the determining whether the frame mapping is C11/DS1 or C12/E1, if the frame mapping is determined to be TUG-2, comprises:
successively testing C1/DS1 tributaries until a C11/DS1 tributary with valid DS1 framing is found,
if a C11/DS1 tributary with valid DS1 framing is found, determining that the frame mapping is DS1,
if no C11/DS1 tributary with valid DS1 framing is found, successively testing C12 μl tributaries until a C12/E1 tributary with valid E1 framing is found,
if a C12/E1 tributary with valid E1 framing is found, determining that the frame mapping is E1, and
if no C12/E1 tributary with valid E3 framing is found, reporting that no valid frame mapping is found to the GUI.

13. The method according to claim 6, wherein the determining whether the frame mapping is DS3, E3, or bulk mapped, if the frame mapping is determined to be C3, comprises:
determining whether a given frame has valid DS3 framing,
if the given fame has valid DS3 framing, determining that the frame mapping is DS3,
if the given fame does not have valid DS3 framing, determining whether the given frame has valid E3 framing,
if the given fame has valid E3 framing, determining that the frame mapping is E3, and
if the given fame does not have valid E3 framing, determining that the frame mapping is bulk mapped.

14. The method according to claim 6, wherein the determining whether the frame mapping is STS-12c or STS-3, if the frame mapping is determined to be OC-12, comprises:
determining whether a pointer in a first H1H2 location is valid,
if the pointer in the first H1H2 location is not valid, reporting a loss of pointer to the GUI,
if the pointer in the first H1H2 location is valid, determining whether pointers in all four H1H2 locations are valid, and
if the pointers in all four H1H2 locations are valid, then determining that the frame mapping is STS-3, else determining that the frame mapping is STS-12c.

15. The method according to claim 6, wherein the determining whether the frame mapping is STS-3c or STS-1, if the frame mapping is determined to be OC-3, comprises:
determining whether a pointer in a first H1H2 location is valid,
if the pointer in the first H1H2 location is not valid, reporting a loss of pointer to the GUI;
if the pointer in the first H1H2 location is valid, determining whether pointers in all three H1H2 locations are valid,
if the pointers in all three H1H2 locations are valid, then initially determining that the frame mapping is STS-1,
if the frame mapping is initially determined to be STS-1, determining whether a label mismatch is present by determining whether a decimal equivalent of a 4 bit number represented by bits 5 through 8 of byte C2 of a given frame equals 2 or 3 or 4,
if the decimal equivalent of the 4 bit number represented by bits 5 through 8 of byte C2 of the given frame equals 2 or 3 or 4, determining there is no label mismatch resulting from the determination of mapping to be STS-1, and finally determining that the frame mapping is STS-1, and
if the decimal equivalent of the 4 bit number represented by bits 5 through 8 of byte C2 of the given frame does not equal 2 or 3 or 4, reporting a label mismatch to the GUI, and finally determining that the frame mapping is STS-1,
if the pointers in all three H1H2 locations are not all valid, then initially determining that the frame mapping is STS-3c,
if the frame mapping is initially determined to be STS-3c, determining whether a label mismatch is present by determining whether a decimal equivalent of a 4 bit number represented by bits 5 through 8 of byte C2 of a given frame equals 13,
if the decimal equivalent of the 4 bit number represented by bits 5 through 8 of byte C2 of the given frame equals 13, determining that there is no label mismatch resulting from the determination of mapping to be STS-3c, and finally determining that the frame mapping is STS-3c, and
if the decimal equivalent of the 4 bit number represented by bits 5 through 8 of byte C2 of the given frame does not equal 13, reporting a label mismatch to the GUI, and finally determining that the frame mapping is STS-3c.

16. The method according to claim 6, wherein the determining whether the frame mapping is VT or STS1-SPE, if the frame mapping is determined to be STS-1, comprises
determining whether a hexadecimal equivalent of byte C2 of a given frame equals 2 or 3,
if the hexadecimal equivalent of byte C2 of the given frame equals 2 or 3, determining that the frame mapping is VT, and
if the hexadecimal equivalent of byte C2 of the given frame does not equal 2 or 3, determining that the frame mapping is STS1-SPE.

17. The method according to claim 6, wherein the determining whether the frame mapping is VT1.5/DS1 or VT2/E1, if the frame mapping is determined to be VT, comprises:
successively testing VT1.5/DS1 tributaries until a VT1.5/DS1 tributary with valid DS1 framing is found,
if a VT1.5/DS1 tributary with valid DS1 framing is found, determining that the frame mapping is DS1,
if no VT1.5/DS1 tributary with valid DS1 framing is found, successively testing VT2/E1 tributaries until a VT2/E1 tributary with valid E1 framing is found,
if a VT2/E1 tributary with valid E1 framing is found, determining that the frame mapping is E1, and
if no VT2/E1 tributary with valid E1 framing is found, reporting that no valid frame mapping is found to the GUI.

18. The method according to claim 6, wherein the determining whether the frame mapping is DS3, E3, or bulk mapped, if the frame mapping is determined to be STS-3, comprises:
determining whether a given frame has valid DS3 framing,
if the given fame has valid DS3 framing, determining that the frame mapping is DS3,
if the given fame does not have valid DS3 framing, determining whether the given frame has valid E3 framing,
if the given fame has valid E3 framing, determining that the frame mapping is E3, and
if the given fame does not have valid E3 framing, determining that the frame mapping is bulk mapped.

19. A network analyzer, comprising
a demultiplexer that demultiplexes an input signal received by the network analyzer; and
a determination unit determining a frame mapping of the input signal, and automatically configuring the demultiplexer in accordance with the determined frame mapping.

20. The network analyzer according to claim 19, further comprising:
a user interface, wherein engaging the user interface initiates the determination of the frame mapping and the automatic configuration of the demultiplexer.

21. The network analyzer according to claim 19, wherein the determining the frame mapping of the input signal comprises:
a combination of examining signal labels of the received input signal, and automated trial and error.

22. The network analyzer according to claim 19, further comprising:
a graphical user interface (GUI) in which a result of the determining of the frame mapping is displayed.

23. The network analyzer according to claim 19, wherein a status of the automatic configuring of the demultiplexer is displayed in the GUI.

24. The network analyzer according to claim 19, wherein the demultiplexer is a SONET/SDH demultiplexer.

25. A network analysis system, comprising:
the network analyzer according to claim 19; and
a computer having a user interface, wherein engaging the user interface initiates the determination of the frame mapping and the automatic configuration of the demultiplexer.

26. A network analysis system, comprising:
the network analyzer according to claim 19; and
a computer having a GUI in which a result of the determining of the frame mapping is displayed.

27. An apparatus, comprising:
a means for receiving an input signal to a network analyzer having a demultiplexer that demultiplexes the received input signal;
a means for determining a frame mapping of the input signal; and
a means for automatically configuring the demultiplexer in accordance with the determined frame mapping.
